(19) United States
(12) Patent Application Publication
(10) Pub. No.: US 2003/0130969 A1
(43) Pub. Date: Jul. 10, 2003

(54) Star intelligent platform management bus topology

(75) Inventors: Peter A. Hawkins, San Luis Obispo, CA (US); Colin N.B. Cook, Riverton, UT (US)

Correspondence Address: Pillsbury Winthrop LLP, Intellectual Property Group, Suite 2800, 725 South Figueroa Street, Los Angeles, CA, 90017-5406, US

(73) Assignee: INTEL CORPORATION

(21) Appl. No.: 10/044,446

(22) Filed: Jan. 10, 2002

(51) Int. Cl. G06G 7/00

(52) U.S. Cl. 706/15

(57) ABSTRACT

A star Intelligent Platform Management Bus (“IPMB”) topology that uses independent intelligent platform management buses between a central Baseboard Management Controller (“BMC”) and various satellite management controllers (“SMCs”) is disclosed. An SMC is any management controller that is not the central BMC. Thus, an SMC may or may not include BMC functionality. The star IPMB topology provides fault isolation such that if a satellite controller fails in a way that corrupts the IPMB to which it is connected, communication is only lost with the failed controller. In addition, the star IPMB topology offers separate address domains whereby multiple controllers can potentially have the same address. The star IPMB topology further offers multiple owner security by isolating each module so that a module's controller can only directly communicate with the central BMC for the chassis.

### BACKGROUND

1. Field of the Invention

Embodiments described herein are directed to a star Intelligent Platform Management Bus (“IPMB”) topology. Specifically, the star IPMB topology uses independent IPMBs between a central Baseboard Management Controller (“BMC”) and multiple satellite management controllers (“SMCs”). An SMC is any management controller that is not the central BMC. As such, an SMC may or may not include BMC functionality.

2. Related Art

In response to central processing unit (“CPU”) performance problems and the need for total server availability, multiple server vendors developed the Intelligent Platform Management Interface (“IPMI”) standard. IPMI is an open standard hardware manageability interface specification that defines how unique devices can communicate with a CPU in a standard fashion. With IPMI, a CPU makes requests and receives information from an IPMI event log through a Baseboard Management Controller (“BMC”). The devices communicate in a standard manner with the IPMI event log, whereby the CPU only inquires about changes in the event log since the previous inquiry. With IPMI, use of the CPU is minimized, thereby allowing overall system performance improvements. IPMI provides a cost-effective and efficient way for a server's CPU to communicate with the devices it needs to monitor.

The IPMI standard includes the following elements: the IPMI, the Intelligent Platform Management Bus (“IPMB”), the Intelligent Chassis Management Bus (“ICMB”), standard message and data formats, satellite management controllers (“SMCs”), and the BMC. The IPMI is the specification for the management controller command sets, including command sets for sensors, event logs, and sensor data record access, as well as the specification for the data formats, including sensor data records, event log entries, and Field Replaceable Unit (“FRU”) inventory information. IPMI is also the name used for the overall standardization effort.

The IPMB is an inter-integrated circuit (“I²C”)-based, multi-master bus used for intra-chassis communication with SMCs. The ICMB is the RS-485 (TIA/EIA Recommended Standard 485A, published Mar. 1, 1998) based inter-chassis management bus, based on IPMB. It is used for common chassis and emergency management functions, including power and reset control, chassis status, events, and FRU inventory. RS-485 is a standard for multipoint communications.

The BMC is used to monitor baseboard temperatures and voltages and to manage the system event log and non-volatile storage for sensor data records. It provides a system software interface to the IPMB. The BMC further manages the interface between the system management software and the platform management hardware, provides recovery control, and serves as a gateway between system management software and the IPMB and the ICMB.

In a typical IPMI based system, a single IPMB provides a communication connection between all of the IPMI controllers in the system. The BMC is one such controller. The other controllers are SMCs. SMCs are management controllers that are distributed within the system, away from a central BMC.

A dual IPMB architecture using two buses to help eliminate single points of failure in a system has been developed. There remains a need, however, for a topology that uses independent IPMBs between the BMC and the various SMCs so as to extend platform management and provide advantages over the standard bus implementation of typical IPMI based systems.

### BRIEF DESCRIPTION OF THE DRAWINGS

A detailed description of embodiments of the invention will be made with reference to the accompanying drawings, wherein like numerals designate corresponding parts in the several figures.

FIG. 1 is a block diagram of the main components of a computer system supporting an intelligent platform management interface, according to an embodiment of the present invention.

FIG. 2 is an illustration of the architecture of a star intelligent platform management bus, according to an embodiment of the present invention.

### DETAILED DESCRIPTION

The following paragraphs describe a star intelligent platform management bus (“IPMB”) 110 topology. IPMB 110 is an inter-integrated circuit (“I²C”)-based bus that provides a standardized interconnection between different modules within a chassis. Intelligent devices that use IPMB 110 are typically controllers that perform platform management functions. Platform management refers to the monitoring and control functions that are built into platform hardware and are primarily used for monitoring the health of system hardware. This generally includes monitoring elements such as system temperatures, voltages, fans, power supplies, bus errors, and system physical security. It also includes automatic and manually driven recovery capabilities such as local or remote system resets and power on/off operations. It further includes the logging of abnormal or out-of-range conditions for later examination and alerting where the platform issues the alert without aid of run-time software. Moreover, it includes inventory information that can help identify a failed hardware unit.

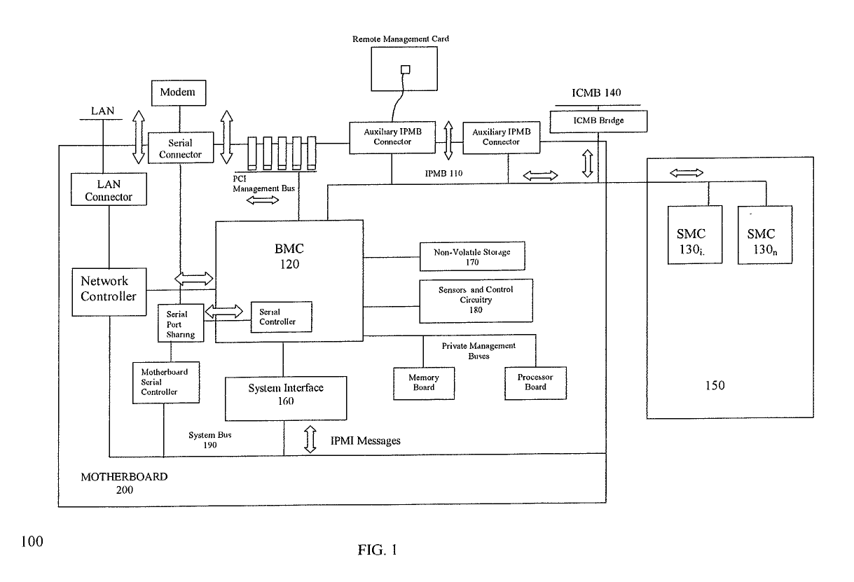

FIG. 1 shows the main components of an Intelligent Platform Management Interface (“IPMI”) 100 (current version 1.5, revision 1.0, Feb. 21, 2001, published by Intel Corporation, Hewlett-Packard Company, NEC Corporation, and Dell Computer Corporation). IPMI 100 is a hardware level interface specification that is management software neutral, providing monitoring and control functions that can be exposed through standard management software interfaces such as, for example, Desktop Management Interface (“DMI”), Windows Management Instrumentation (“WMI”), Common Information Model (“CIM”), and Simple Network Management Protocol (“SNMP”). As a hardware level interface, it sits at the bottom of a typical management software stack. IPMI 100 is best used in conjunction with system management software running under the operating system. This provides an enhanced level of manageability by providing in-band access to the IPMI 100 management information and integrating IPMI 100 with the additional management functions provided by management applications and the operating system.

At the heart of the IPMI 100 architecture is a microcontroller known as the Baseboard Management Controller (“BMC”) 120. The BMC 120 provides the intelligence behind intelligent platform management. The BMC 120 manages the interface between system management software and the platform management hardware, provides autonomous monitoring, event logging, and recovery control and serves as the gateway between system management software and the IPMB 110 and an Intelligent Chassis Management Bus (“ICMB”) 140.

The BMC 120 is connected to a system bus 190 on the computer chassis motherboard 200 through a system interface 160. The motherboard 200 is then connected to a network controller and a network connector such as a Local Area Network (“LAN”) or Wide Area Network (“WAN”) connector, which is then coupled to a LAN or a WAN.

The BMC 120 may include or be connected to a non-volatile storage unit 170. This non-volatile storage unit 170 may include a system event log, a sensor data record repository, and a baseboard Field Replaceable Unit (“FRU”) information database. The BMC 120 may further include or be connected to sensors and control circuitry 180 for monitoring voltages, temperatures, power, reset control, fans, etc. The BMC 120 may also be connected to private management buses that are coupled to memory and processor modules.

IPMI 100 supports the extension of platform management by connecting additional satellite management controllers (“SMCs”) 130 to the system using the IPMB 110. IPMI's 100 support for multiple SMCs 130 shows that the architecture is scalable. The SMCs 130 reside on a chassis module 150. SMCs 130 receive command messages from the BMC 120. The SMC 130 accepts the command message from the BMC 120, gathers the information from the appropriate device such as a sensor, packages the information in the appropriate transmission format, and transmits the response message with the information over the IPMB 110 to the BMC 120. The SMC 130 may also send event messages to the BMC 120 if a sensor detects an event. Events may include out-of-range values, crossed thresholds, etc. If the SMC 130 interface is located in another computer chassis module 150, messages are sent over the ICMB 140.

ICMB 140 is the RS-485 (TIA/EIA Recommended Standard 485A, published Mar. 1, 1998) based inter-chassis management bus, based on IPMB 110. It is used for common chassis and emergency management functions, including power and reset control, chassis status, events, and FRU inventory. RS-485 is the standard for multipoint communications. Coupled to the ICMB 140 is an ICMB 140 bridge that includes RS-485 transceivers as well as a microcontroller.

The IPMB 110 (current version 1.0, revision 1.0, Nov. 15, 1999, published by Intel Corporation, Hewlett-Packard Company, NEC Corporation, and Dell Computer Corporation) is the standardized bus and protocol for extending management control, monitoring, and event delivery within the chassis. The IPMB 110 is used for communication to and between the various controllers such as the BMC 120 and the SMC 130.

The IPMB 110 architecture and protocol addresses several goals. The IPMB 110 supports a distributed platform management architecture. Sensors and controllers may be located on the managed modules and their information consolidated via the IPMB 110. This yields a more flexible design than one in which all sensors must be directly routed to a central point of management.

The IPMB 110 further supports asynchronous event notification and critical event logging. The IPMB 110 implements a multi-master protocol that allows intelligent controllers to arbitrate the bus for the purpose of sending an event message to an event receiver node. This provides a mechanism whereby a controller can raise an asynchronous event.

The IPMB 110 provides an extensible platform management infrastructure. New management information sources can be readily added to the IPMB 110 without impacting other controllers on the bus. The IPMB 110 implements a multi-master operation to support the distributed management architecture, asynchronous event notification, and platform extensibility. The mechanism supports direct communication between any two intelligent devices on the bus.

The IPMB 110 is designed to allow non-intelligent I²C devices to co-reside on the IPMB 110. Such devices, including I/O ports for example, may be incorporated as part of the platform management system. Such devices can be accessed directly or can be managed as devices that are owned by an intelligent controller.

The IPMB 110 is separate from the system's processor and memory buses. As such, it remains available even if a failure prevents the system from running. It is possible for the IPMB 110 to be augmented by system management add-in cards, such as autonomous management cards that connect to the management bus and allow management data to be delivered to a remote console via a telephone line or a LAN connection.

The IPMB 110 provides an inexpensive, low-pin count, communication media for platform management information. Miscellaneous system cabling functions, such as the routing of fault signals between modules, can be replaced by using the IPMB 110. A dedicated wire is typically used only to communicate a single piece of management information, whereas the IPMB 110 carries whole streams of data. Moreover, the ICMB 140 protocol provides a route to interchassis management. This is accomplished by store-and-forward type devices referred to as bridge nodes. Bridge nodes isolate the internal management bus address spaces in order to eradicate any concern about address conflicts between the internal nodes in one chassis and those in another.

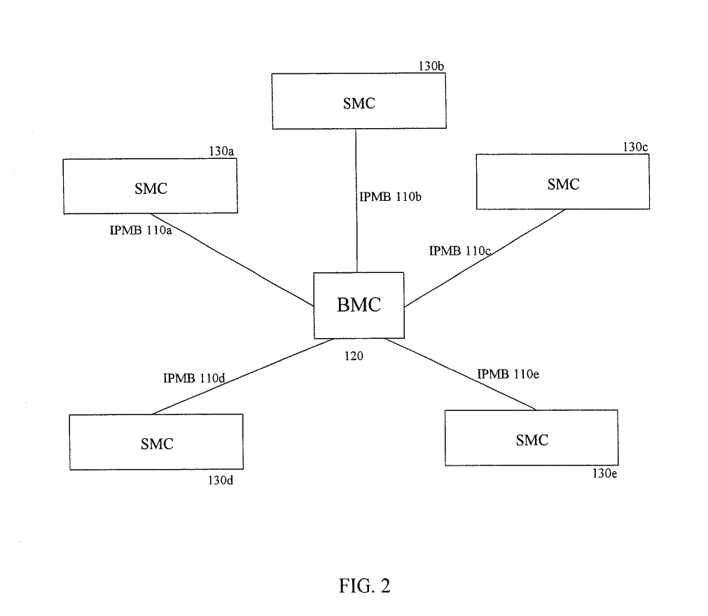

FIG. 2 illustrates a star IPMB 110 topology. BMC 120 is shown connected to SMCs 130a-e. Instead of a single IPMB 110 providing a communication connection between the BMC 120 and the SMCs 130a-e, independent IPMBs 110a-e are implemented. This star IPMB 110 topology offers several features over the standard bus implementation. Fault isolation is one such improvement over typical IPMI 100 based systems. That is, if SMC 130a fails in such a way that it corrupts IPMB 110a to which it is connected, a bused implementation would lose all communication among SMCs 130a-e and the BMC 120. With a star IPMB 110 topology, this type of failure would only cause communication to be lost with the failed SMC 130a.

An additional advantage of the star IPMB 110 topology is that it offers separate address domains. In a typical IPMI 100 based bused system, the BMC 120 and all SMCs 130a-e must have a unique address. With a star IPMB 110 topology, multiple controllers can potentially have the same address. This feature is especially useful in rack systems, e.g. Compact Peripheral Component Interconnect (“CompactPCI”), where multiple modules may implement several BMCs 120, which are all addressed at bus address 20h.

Moreover, the star IPMB 110 topology offers multiple owner security. In a rack system such as that of CompactPCI, multiple owners may have modules in the same chassis. In a bused system, one owner or a hacker compromising one owner's module can send IPMI 100 commands to another owner's module, possibly causing undesirable behavior. Even with encryption and authentication in a bused system, an owner or a hacker can present a denial of service (“DOS”) attack by flooding the common IPMB 110 with messages. The star IPMB 110 topology isolates each module so that a module's controller can only directly communicate with the central BMC 120 for the chassis.

While the above description refers to particular embodiments of the present invention, it will be understood to those of ordinary skill in the art that modifications may be made without departing from the spirit thereof The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

What is claimed is:

1. A star intelligent platform management bus topology, comprising:
a central baseboard management controller, coupled to a plurality of management controllers, to provide autonomous monitoring, event logging, and recovery control;
the plurality of management controllers, to receive a command message from the central baseboard management controllers, to gather information from a device, to package the information, and to transmit a response message with the information to the central baseboard management controller; and
a plurality of intelligent platform management buses that provide a communication connection between the central baseboard management controller and the plurality of management controllers, wherein the star intelligent platform management bus topology is adapted to:
provide fault isolation;
provide separate address domains; and
provide multiple owner security within a chassis.

2. The star intelligent platform management bus topology of claim 1, wherein the central baseboard management controller includes or is connected to a non-volatile storage unit, and the non-volatile storage unit has a system event log, a sensor data record depository, and a baseboard field replaceable unit information module.

3. The star intelligent platform management bus topology of claim 1, wherein the central baseboard management controller includes or is connected to sensors and control circuitry to monitor voltages, temperatures, power, fans, and reset control.

4. The star intelligent platform management bus topology of claim 1, wherein the central baseboard management controller is the gateway between system management software and platform management hardware.

5. The star intelligent platform management bus topology of claim 4, wherein the platform hardware management includes the plurality of intelligent platform management buses and an intelligent chassis management bus, and the intelligent chassis management bus is used for power and reset control, chassis status, events, and field replaceable unit inventory.

6. The star intelligent platform management bus topology of claim 1, wherein the plurality of management controllers resides on at least one chassis module.

7. The star intelligent platform management bus topology of claim 1, wherein the plurality of management controllers gather information from sensors and package the information in suitable transmission formats for sending via the plurality of intelligent platform management buses, which are adapted to carry streams of data.

8. The star intelligent platform management bus topology of claim 1, wherein each of the plurality of management controllers is coupled to one of the plurality of intelligent platform management buses.

9. The star intelligent platform management bus topology of claim 8, wherein at least one of the plurality of management controllers is replaced with at least one remote baseboard management controller so that the central baseboard management controller appears as a satellite management controller without baseboard management controller functionality to the at least one remote baseboard management controller.

10. The star intelligent platform management bus topology of claim 1, wherein if one of the plurality of management controllers fails in such a way that it corrupts the intelligent platform management bus to which it is coupled, communication is lost with only the failed management controller so as to provide fault isolation.

11. The star intelligent platform management bus topology of claim 1, wherein the baseboard management controller and the plurality of management controllers share addresses.

12. The star intelligent platform management bus topology of claim 1, wherein each of a plurality of modules is isolated so that a controller of a module communicates directly with only a central baseboard management controller associated with the chassis to provide multiple owner security.

13. An intelligent management platform interface that allows communication between a central processing unit and a plurality of controllers, comprising:
an intelligent platform management interface that provides monitoring and control functions;
a plurality of intelligent platform management buses for communication to and between the plurality of controllers and for extending management control, monitoring, and event delivery within a chassis;
an intelligent chassis management bus for chassis and emergency management functions including power and reset control, chassis status, events, and inventory;
a central baseboard management controller, connected to a plurality of management controllers via the plurality of intelligent platform management buses;
wherein the plurality of intelligent platform management buses are arranged in a star topology to provide fault isolation, separate address domains, and multiple owner security.

14. The intelligent platform management interface of claim 13, wherein the plurality of intelligent platform management buses are inter-integrated circuit bus based.

15. The intelligent platform management interface of claim 13, wherein the central processing unit requests and receives information from an intelligent platform management interface event log through the central baseboard management controller.

16. The intelligent platform management interface of claim 15, wherein the central processing unit inquires about changes in the event log since a previous inquiry.

17. The intelligent platform management interface of claim 13, wherein the central baseboard management controller is connected to a system bus on a computer chassis motherboard through a system interface.

18. The intelligent platform management interface of claim 17, wherein the motherboard is connected to a network controller and a network connector.

19. The intelligent platform management interface of claim 13, wherein the intelligent chassis management bus is RS-485 based and is coupled to RS-485 transceivers.

20. The intelligent platform management interface of claim 13, wherein if at least one of the plurality of management controllers fails, the star topology allows continued communication between the central baseboard management controller and any non-failing management controller from the plurality of management controllers.

21. The intelligent platform management interface of claim 13, wherein the star topology provides separate address domains to the central baseboard management controller and the plurality of management controllers thus allowing address sharing.

22. The intelligent platform management interface of claim 13, wherein the star topology isolates each of a plurality of modules such that a controller of a module only communicates directly with the central baseboard management controller for the chassis.

23. A method of configuring a star intelligent platform management bus topology, comprising:
providing a central baseboard management controller;
providing a first management controller;
connecting the central baseboard management controller to the first management controller via a first intelligent platform management bus;
providing a second management controller; and
connecting the central baseboard management controller to the second management controller via a second intelligent platform management bus.

24. The method of claim 23, wherein the first management controller and the second management controller reside on at least one chassis module and accept command messages from the central baseboard management controller, gather information from sensors, package the information into a suitable transmission format, and transmit a response message with the information over the first and second intelligent platform management buses to the central baseboard management controller.

25. The method of claim 24, wherein the first management controller and the second management controller send event messages to the central baseboard management controller.

26. The method of claim 23, wherein the central baseboard management controller manages an intelligent platform management interface event log, monitors voltages, temperatures, power, reset control, and fans, and manages a non-volatile storage for data records.

27. The method of claim 26, wherein a central processing unit requests and receives information from the intelligent platform management interface event log through the central baseboard management controller and inquires about changes in the event log since a previous inquiry.

28. The method of claim 23, wherein the star intelligent platform management bus topology provides fault isolation by maintaining continued communication between the central baseboard management controller and one of the first management controller and the second management controller if one of the first management controller and the second management controller fails.

29. The method of claim 23, wherein the star intelligent platform management bus topology provides separate address domains to the central baseboard management controller, the first management controller, and the second management controller to allow address sharing.

30. The method of claim 23, wherein the star intelligent platform management bus topology isolates each of a plurality of chassis modules such that a controller of a module only communicates directly with the central baseboard management controller for the chassis module to provide multiple owner security.
